(19) United States
(12) Patent Application Publication
(10) Pub. No.: US 2025/0323845 A1
(43) Pub. Date: Oct. 16, 2025

(54) AI-Powered System and Method for Context-Aware Customer Re-engagement Following Telecommunication Disconnections

(71) Applicant: Daniel Goldsmith, Sacramento, CA (US)

(72) Inventor: Daniel Goldsmith, Sacramento, CA (US)

(21) Appl. No.: 18/633,554

(22) Filed: Apr. 12, 2024

(51) Int. Cl. H04L 41/5061; G10L 13/04; H04L 41/16

(52) U.S. Cl. CPC H04L 41/5064; G10L 13/04; H04L 41/16

(57) ABSTRACT

The disclosed invention presents a computer-implemented method designed to re-engage users after telecommunication disconnections, enhancing the continuity of communication between businesses and customers. The method is executed by one or more servers in communication with a user device and encompasses several steps to ensure an efficient re-engagement process. Initially, the method involves monitoring telecommunication interactions between user devices to detect any disconnection event. Upon detecting a disconnection, the system categorizes the nature of the disconnection and analyzes the context of the interaction prior to the event. Utilizing an artificial intelligence and machine learning engine, a contextually relevant response is generated. This response is then converted into an audio message that replicates the agent's voice involved in the initial communication, and finally, the message is transmitted to the user device to facilitate re-engagement. This method aims to maintain seamless communication flows, offering a personalized and responsive approach to managing call disconnections.

### FIELD OF INVENTION

The present invention relates generally to the field of artificial intelligence and telecommunication, specifically to systems and methods for enhancing customer service through AI-powered re-engagement strategies following call disconnections. It utilizes advanced voice mimicking and context analysis technologies to provide personalized, efficient post-disconnection customer interactions.

### BACKGROUND

In today's fast-paced digital era, telecommunication remains a pivotal channel for customer interactions across various industries. Despite advancements in technology, businesses continue to face substantial challenges in maintaining uninterrupted communication with customers. One significant issue that exacerbates customer dissatisfaction and potentially leads to lost revenue is call disconnection. Such disconnections, whether due to technical glitches, network issues, or by the customer's choice, disrupt the flow of conversation and, more critically, the opportunity to address the customer's needs effectively.

Recognizing the importance of sustaining customer engagement, the industry has seen efforts to deploy solutions aimed at re-establishing connection post-disconnection. However, these existing methods often lack the sophistication and personalization necessary to seamlessly resume the interrupted interaction, resulting in a disjointed customer experience. Traditional callback systems, for instance, merely aim to reconnect the call without adequately addressing the context of the disconnection or the continuity of the conversation, leaving customers feeling undervalued and frustrated.

Furthermore, the impersonal nature of current automated systems fails to replicate the nuanced understanding and empathy of human agents, leading to a generic and often irrelevant engagement that does not cater to the individual's immediate needs or preferences. This gap in effectively understanding and acting upon the specific context of each disconnection not only diminishes the quality of customer service but also overlooks potential opportunities for businesses to offer alternative solutions or services that might better meet the customer's requirements.

Moreover, the integration of artificial intelligence (AI) and machine learning in customer service applications has predominantly been focused on initial engagement and query resolution, with less emphasis on the critical aspect of maintaining conversation continuity after unforeseen interruptions. This oversight highlights a pressing need for a more innovative approach that combines state-of-the-art AI capabilities, including voice mimicking technology and context-aware response generation, to offer a more personalized and efficient re-engagement strategy post-disconnection.

The advent of such technology promises to revolutionize how businesses handle call disconnections, transitioning from a reactive to a proactive customer engagement model. By harnessing AI to analyze the context of the conversation and employing advanced voice synthesis to continue the dialogue in the agent's voice, this novel approach aims to not only mitigate the negative impact of call disconnections but also enhance the overall customer experience through seamless, relevant, and timely re-engagement.

This pressing need for a more sophisticated solution to address the inherent limitations of existing customer re-engagement efforts, combined with the potential benefits of leveraging AI and voice mimicking technology, underscores the significance of developing an innovative software capable of transforming disconnected calls into opportunities for enhancing customer satisfaction and operational efficiency.

It is within this context that the present invention is provided.

### SUMMARY

The invention encompasses a computer-implemented method for re-engaging users following telecommunication disconnections, executed by one or more servers in communication with a user device. This method involves monitoring telecommunication interactions to detect disconnections, categorizing the nature of these disconnections, analyzing the context of the interaction prior to disconnection, generating a contextually relevant response, converting this response into an audio message that replicates the agent's voice, and transmitting the message to re-engage the user. This method provides a systematic approach to maintaining communication continuity and enhancing the user re-engagement process after disconnections.

In some embodiments, the method includes initiating contact with the user device immediately after the disconnection event to ensure prompt re-engagement. This feature ensures that the engagement process is not only reactive but also proactive, aiming to minimize any potential disruption in communication.

In some embodiments, the voice synthesis module of the method integrates speech-to-text and text-to-speech technologies. This integration facilitates a more natural and seamless conversion of the generated response into an audio message, enhancing the user experience by maintaining the continuity and personalization of the interaction.

In some embodiments, an alternative communication method is triggered based on the user's response or the nature of the disconnection. This could include sending a text message to the user device, providing flexibility in the re-engagement strategy and catering to the preferred communication methods of the user.

In some embodiments, the artificial intelligence and machine learning engine uses Python with TensorFlow or PyTorch. This utilization signifies the method's reliance on advanced computational frameworks to analyze the context of telecommunication interactions and generate relevant responses, thereby ensuring a high level of accuracy and relevance in the re-engagement process.

In some embodiments, the signal processing and detection unit is configured to distinguish between different types of disconnection events. This distinction allows for tailored re-engagement strategies that are responsive to the specific circumstances surrounding each disconnection, thereby enhancing the effectiveness of the re-engagement process.

In some embodiments, the customer interaction history database stores data on previous communications. This information supports a comprehensive analysis of the interaction context, enabling a more informed and customized approach to generating the re-engagement response.

In some embodiments, voice mimicking employs either Google Cloud Speech API or Amazon Polly in the voice synthesis module. This choice of technology underscores the method's capability to produce highly accurate and natural-sounding voice replications, further personalizing the re-engagement experience.

In some embodiments, the method is tailored for scenarios involving offers of products or services. This specificity ensures that the re-engagement is not only relevant but also potentially valuable to the user, aligning with their needs and preferences.

In some embodiments, the generated response includes an offer for an alternative service or product. This approach maximizes the potential for revenue generation and customer satisfaction by leveraging the context of the initial interaction and the preferences identified therein.

In some embodiments, the effectiveness of the re-engagement strategy is analyzed by monitoring the user's interaction with the transmitted audio message. This analysis allows for continuous improvement of the re-engagement process based on user feedback and interaction patterns.

In some embodiments, the method is integrated into a customer service platform supporting multiple communication channels. This integration ensures that the most appropriate channel is selected for re-engagement, based on the user's preferences and the specific nature of the disconnection.

In some embodiments, the artificial intelligence and machine learning engine learns from each re-engagement instance. This learning process continuously improves the accuracy of context analysis and response generation, enhancing the effectiveness and relevance of re-engagement attempts over time.

### BRIEF DESCRIPTION OF THE DRAWINGS

Various embodiments of the invention are disclosed in the following detailed description and accompanying drawings.

FIG.1 illustrates an example system architecture showing all necessary components and their interconnectivity for re-engaging customers after a call disconnection, including a server, database, user devices, and a block diagram of the software.

FIG.2 illustrates an example operational workflow diagram detailing the step-by-step process from call initiation to re-engagement, highlighting the detection of disconnections, voice analysis, and the generation and delivery of a personalized audio message.

FIG.3 illustrates an example flow diagram of the voice mimicking process, demonstrating the steps involved in synthesizing an agent's voice to create a personalized audio message for re-engagement following a telecommunication disconnection.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### DEFINITIONS

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The terms “first,” “second,” and the like are used to distinguish different elements or features, but these elements or features should not be limited by these terms. A first element or feature described can be referred to as a second element or feature and vice versa without departing from the teachings of the present disclosure.

A “user device” as described herein refers to any electronic device capable of participating in telecommunication interactions. This may include, but is not limited to, smartphones, tablets, desktop computers, laptops, smartwatches, and any other devices equipped with telecommunication capabilities. User devices may operate using a variety of operating systems such as IOS, Android, Windows, macOS, and others, and can connect to telecommunications networks via wired or wireless protocols including, but not limited to, Ethernet, Wi-Fi, Bluetooth, Near Field Communication (NFC), and cellular networks such as 4G LTE and 5G.

The term “telecommunication interaction” encompasses any form of digital communication between two or more parties over a distance. This includes voice calls, video calls, text messaging, email exchanges, and other forms of digital communication facilitated by telecommunication networks. Telecommunication interactions can occur over various platforms, including traditional telephony networks, Voice over Internet Protocol (VoIP) services like Skype or Zoom, and messaging platforms such as WhatsApp or Telegram.

An “artificial intelligence and machine learning engine” as utilized in the disclosed method may be implemented using a variety of software frameworks and libraries designed for AI and machine learning tasks. Examples include TensorFlow, developed by the Google Brain team, and PyTorch, developed by Facebook's AI Research lab. These frameworks can be deployed on various hardware platforms, including servers equipped with high-performance GPUs for accelerated computing tasks related to AI and machine learning, such as neural network training and inference.

The “voice synthesis module” involved in converting generated text responses into audio messages may leverage advanced text-to-speech (TTS) technologies. Example implementations could include Google Cloud Text-to-Speech and Amazon Polly, which offer a wide range of lifelike voices and support for multiple languages. These platforms utilize deep learning technologies to produce speech that closely mimics human voices, offering customizable inflection, tone, and pacing.

A “signal processing and detection unit” within the system may be configured to detect and categorize disconnection events using algorithms designed to analyze network signals and communication protocols. This unit could be implemented using software libraries such as SciPy or NumPy in Python, which offer extensive functionality for signal processing. The detection and categorization process may involve analyzing packet loss, signal strength, network latency, and other factors indicative of telecommunication disconnections.

### Description of Drawings

The present invention pertains to a computer-implemented method and system for re-engaging users after telecommunication disconnections. This invention is designed to operate within a telecommunications environment, leveraging artificial intelligence (AI) and machine learning to analyze the context of disconnections and generate responses tailored to the specific circumstances of each disconnection event. The system executes this method through a series of coordinated actions between one or more servers and user devices, aiming to restore communication seamlessly and maintain the continuity of the interaction.

The core of the invention is built around the detection of telecommunication disconnections, the categorization of these disconnections based on their nature, and the subsequent analysis of the communication's context prior to the disconnection. Upon this foundation, the invention utilizes an AI and machine learning engine to formulate a response that is relevant to the analyzed context. This response is then converted into an audio message through a voice synthesis module that replicates the voice of the initial human agent, thereby providing a personalized re-engagement attempt. The system concludes this process by transmitting the audio message to the user device, thereby attempting to re-establish the interrupted communication.

This method and system are implemented on a technological platform that includes hardware components such as servers equipped with processors capable of executing the described software functions. These components work in concert to monitor telecommunication interactions, process data related to these interactions, and execute the AI-driven re-engagement strategy.

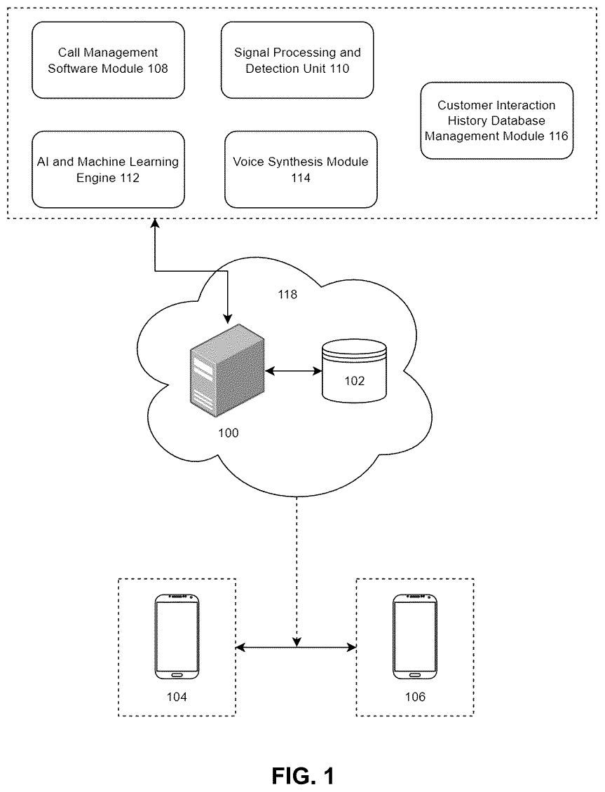

Referring to FIG.1, an example implementation of a first embodiment of the invention is illustrated, wherein the system architecture is detailed to demonstrate the comprehensive approach to re-engaging users following telecommunication disconnections.

At the heart of this architecture is the server 100, which operates within a cloud-based environment to ensure scalable and efficient processing capabilities. The server 100 is tasked with executing the majority of the computational processes inherent to the invention, including the monitoring of telecommunication interactions, disconnection detection, and the generation of contextually relevant responses.

In close association with the server 100 is the database 102, also situated within the cloud architecture. The database 102 serves stores interaction data, which includes but is not limited to, previous communication logs, user preferences, and other relevant metadata that aids in the analysis of the telecommunication interaction's context prior to disconnection. This data repository enables the artificial intelligence and machine learning engine to tailor its responses more accurately to the user's needs and the specific circumstances surrounding the disconnection event.

Communication between user devices is a fundamental aspect of the system's operational environment. A set of one or more first user devices 104 is depicted as being in telecommunication with one or more second user devices 106. These user devices can range from smartphones, tablets, to desktop computers, and are equipped to engage in various forms of digital communication, including voice and video calls, text messaging, and email exchanges. The interaction between the first user devices 104 and the second user devices 106 over telecommunication networks is monitored by the server 100 to detect any instances of disconnection.

Operating through the server is the Call Management software module 108 of the invention itself, which is divided into sub-modules that collectively contribute to the invention's operation.

These modules include the signal processing and detection unit 110, the artificial intelligence and machine learning engine 112, the voice synthesis module 114, and the customer interaction history database management module 116.

The signal processing and detection unit 110 is responsible for monitoring telecommunication interactions to identify disconnections, employing algorithms that can distinguish between different types of disconnection events. The artificial intelligence and machine learning engine 112 utilizes software frameworks such as TensorFlow or PyTorch for analyzing the context of the conversation and generating appropriate responses. The voice synthesis module 114, possibly integrating technologies like Google Cloud Text-to-Speech or Amazon Polly, converts these responses into audio messages in the agent's voice. Lastly, the customer interaction history database management module 116 oversees the storage and retrieval of data from the database 102, ensuring that the AI engine has access to comprehensive interaction histories for context analysis.

The components within the system architecture are interconnected via a network 118, which facilitates data exchange and communication across the cloud architecture, between the server 100, the database 102, and the user devices 104, 106. This network 118 supports various protocols to ensure secure and reliable communication, including but not limited to, TCP/IP for internet communications, and HTTPS for secure web traffic.

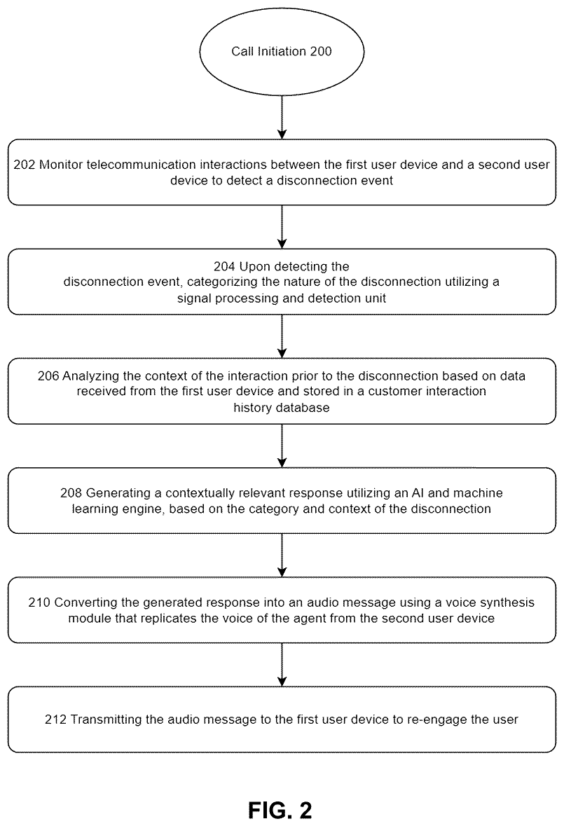

Referring to FIG.2, an operational workflow diagram details the systematic process from the initiation of a call to re-engagement following a telecommunication disconnection.

The process begins with call initiation 200, where a communication link is established between a first user device and a second user device. This initial phase is critical for setting up the context for the subsequent monitoring activities.

The next phase involves monitoring the call 202, conducted by the server. This monitoring is aimed at detecting any interruption in the call flow, utilizing algorithms capable of identifying disconnection events with precision.

Upon detecting a disconnection, the server proceeds to categorize the disconnection 204. This step involves analyzing the nature of the disconnection, distinguishing between different types based on predefined criteria. This categorization is facilitated by the signal processing and detection unit within the server.

Following the categorization, the server analyzes the context of the call 206, employing data from the customer interaction history database. This analysis is performed by the artificial intelligence and machine learning engine.

The engine examines the content and dynamics of the conversation to generate 208 a response that is relevant to the situation at hand.

The generated response is then converted into an audio message 210 using the voice synthesis module. This module employs text-to-speech technology to create an audio message that mimics the voice of the initial human agent, ensuring the message is personalized and engaging.

The final step in the workflow is the transmission of the audio message 212 to the first user device. This step aims to re-establish communication with the user, delivering the audio message via the telecommunications network using secure transmission protocols.

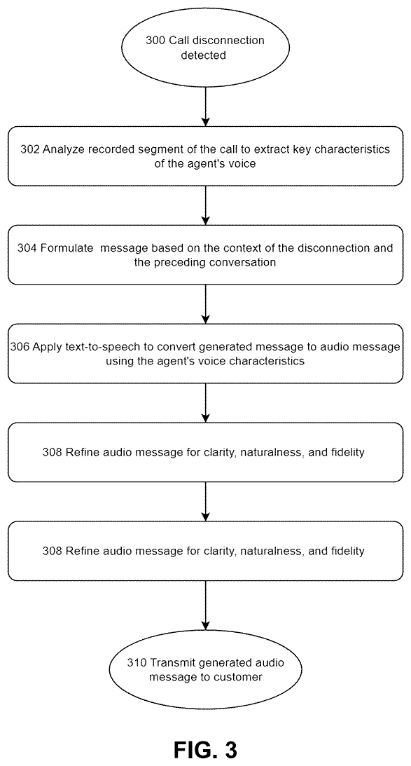

Referring to FIG.3, a flow diagram is presented illustrating the voice mimicking process, which is integral to the re-engagement strategy following a telecommunication disconnection. This diagram provides a step-by-step visualization of how the software synthesizes the voice of an agent to create a personalized audio message for the customer, utilizing the agent's voice characteristics captured prior to the disconnection.

The process begins with call disconnection detection 300, where the system identifies a disconnection in the telecommunication interaction. This detection is facilitated by the signal processing and detection unit within the server, leveraging algorithms designed to promptly recognize interruptions in communication.

Following the detection, the process moves to voice analysis 302. In this phase, the software analyzes a recorded segment of the call to extract key characteristics of the agent's voice, such as tone, pitch, speed, and accent. This analysis relies on advanced voice recognition technologies that can accurately capture and replicate the nuances of human speech.

Simultaneously, the system generates a text message intended for the customer at text generation 304. This message is formulated based on the context of the disconnection and the preceding conversation, ensuring relevance and continuity. The artificial intelligence and machine learning engine, utilizing natural language processing capabilities, crafts this message to address the customer's needs effectively.

At voice synthesis 306, the extracted voice characteristics and the generated text message converge. This step employs text-to-speech (TTS) technology, possibly integrating platforms like Google Cloud Text-to-Speech or Amazon Polly, to synthesize the audio message. The objective here is to produce an output that closely mimics the agent's voice, maintaining a personal touch in the re-engagement attempt.

Audio message refinement 308 may follow, where the synthesized audio message undergoes further processing to enhance clarity, naturalness, and fidelity. This refinement ensures that the message not only replicates the agent's voice but also delivers the content in a manner that is easily understandable and engaging for the customer.

The final step illustrated in the diagram is the transmission to customer 310. Here, the refined audio message is sent to the customer's device, utilizing telecommunications networks to facilitate the re-engagement. The server ensures secure and reliable delivery of the message, employing appropriate communication protocols to re-establish connection with the customer.

### Controller/Processor Components

A controller or processor as described herein can be any suitable type of computer. A computer may be a uniprocessor or multiprocessor machine. Accordingly, a computer may include one or more processors and, thus, the aforementioned computer system may also include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), gated logic, programmable control boards (PCBs), and other suitable hardware configured to perform the various functionality described throughout this disclosure.

Additionally, the computer may include one or more memories. Accordingly, the aforementioned computer systems may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, video tapes, audio tapes, magnetic recording tracks, magnetic tunnel junction (MTJ) memory, optical memory storage, quantum mechanical storage, electronic networks, and/or other devices or technologies used to store electronic content such as programs and data. In particular, the one or more memories may store computer executable instructions that, when executed by the one or more processors, cause the one or more processors to implement the procedures and techniques described herein. The one or more processors may be operably associated with the one or more memories so that the computer executable instructions can be provided to the one or more processors for execution. For example, the one or more processors may be operably associated to the one or more memories through one or more buses. Furthermore, the computer may possess or may be operably associated with input devices (e.g., a keyboard, a keypad, controller, a mouse, a microphone, a touch screen, a sensor) and output devices such as (e.g., a computer screen, printer, or a speaker).

The computer may advantageously be equipped with a network communication device such as a network interface card, a modem, or other network connection device suitable for connecting to one or more networks.

A computer may advantageously contain control logic, or program logic, or other substrate configuration representing data and instructions, which cause the computer to operate in a specific and predefined manner as, described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro code, circuitry, data, and/or the like.

The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells.

The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general-purpose computing machines or devices may be used with programs constructed in accordance with some of the teachings described herein. In some embodiments, very specific computing machines, with specific functionality, may be required.

Referring to FIG.3, a flow diagram is presented illustrating the voice mimicking process, which is integral to the re-engagement strategy following a telecommunication disconnection. This diagram provides a step-by-step visualization of how the software synthesizes the voice of an agent to create a personalized audio message for the customer, utilizing the agent's voice characteristics captured prior to the disconnection.

The process begins with call disconnection detection 300, where the system identifies a disconnection in the telecommunication interaction. This detection is facilitated by the signal processing and detection unit within the server, leveraging algorithms designed to promptly recognize interruptions in communication.

Following the detection, the process moves to voice analysis 302. In this phase, the software analyzes a recorded segment of the call to extract key characteristics of the agent's voice, such as tone, pitch, speed, and accent. This analysis relies on advanced voice recognition technologies that can accurately capture and replicate the nuances of human speech.

Simultaneously, the system generates a text message intended for the customer at text generation 304. This message is formulated based on the context of the disconnection and the preceding conversation, ensuring relevance and continuity. The artificial intelligence and machine learning engine, utilizing natural language processing capabilities, crafts this message to address the customer's needs effectively.

At voice synthesis 306, the extracted voice characteristics and the generated text message converge. This step employs text-to-speech (TTS) technology, possibly integrating platforms like Google Cloud Text-to-Speech or Amazon Polly, to synthesize the audio message. The objective here is to produce an output that closely mimics the agent's voice, maintaining a personal touch in the re-engagement attempt.

Audio message refinement 308 may follow, where the synthesized audio message undergoes further processing to enhance clarity, naturalness, and fidelity. This refinement ensures that the message not only replicates the agent's voice but also delivers the content in a manner that is easily understandable and engaging for the customer.

The final step illustrated in the diagram is the transmission to customer 310. Here, the refined audio message is sent to the customer's device, utilizing telecommunications networks to facilitate the re-engagement. The server ensures secure and reliable delivery of the message, employing appropriate communication protocols to re-establish connection with the customer.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the method and system of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A computer-implemented method for re-engaging a user after a telecommunication disconnection, the method executed by one or more servers in communication with a first user device, comprising:
a. monitoring, by the one or more servers, telecommunication interactions between the first user device and a second user device to detect a disconnection event;
b. upon detecting the disconnection event, categorizing, by the one or more servers, the nature of the disconnection utilizing a signal processing and detection unit;
c. analyzing, by the one or more servers, the context of the telecommunication interaction prior to the disconnection based on data received from the first user device and stored in a customer interaction history database;
d. generating, by the one or more servers, a contextually relevant response utilizing an artificial intelligence and machine learning engine, where the response is adapted based on the categorized nature of the disconnection and the analyzed context;
e. converting, by the one or more servers, the generated response into an audio message using a voice synthesis module that replicates the voice of the agent from the second user device; and
f. transmitting, by the one or more servers, the audio message to the first user device to re-engage the user.

2. The method of claim 1, further comprising: initiating contact with the first user device utilizing the one or more servers immediately following the disconnection event to ensure prompt re-engagement.

3. The method of claim 1, wherein the voice synthesis module integrates speech-to-text and text-to-speech technologies to facilitate the conversion of the generated response into the audio message.

4. The method of claim 1, further comprising: triggering, by the one or more servers, an alternative communication method based on the user's response to the audio message or the categorized nature of the disconnection, wherein the alternative communication method includes sending a text message to the first user device.

5. The method of claim 1, wherein the artificial intelligence and machine learning engine employs Python with TensorFlow or PyTorch for analyzing the context of the telecommunication interaction and generating the contextually relevant response.

6. The method of claim 1, wherein the signal processing and detection unit is further configured to distinguish between different types of disconnection events, including accidental disconnections and strategic disconnections initiated by the user.

7. The method of claim 1, wherein the customer interaction history database stores interaction data including previous communications between the first user device and the second user device, which is utilized in analyzing the context of the telecommunication interaction.

8. The method of claim 1, further comprising: employing the voice synthesis module to implement voice mimicking using either Google Cloud Speech API or Amazon Polly for the conversion of the generated response into the audio message.

9. The method of claim 1, wherein the method is further configured for application in scenarios where the telecommunication interaction is related to offering products or services, and the re-engagement is tailored to offer alternative products or services based on the analyzed context and the user's needs.

10. The method of claim 1, further comprising: adapting the generated response to include an offer for an alternative service or product when the initial interaction prior to disconnection was related to a specific offer, wherein the adaptation is based on the likelihood of matching the user's preferences and potential for revenue generation identified through the context analysis.

11. The method of claim 1, wherein the one or more servers are further configured to:
analyze the effectiveness of the re-engagement strategy by monitoring the user's interaction with the transmitted audio message and adjusting future responses based on this analysis.

12. The method of claim 1, further comprising: integrating the method into a customer service platform that supports multiple communication channels, including voice calls and SMS, enabling the system to select the most appropriate channel for re-engagement based on the user's previous communication preferences and the nature of the disconnection.

13. The method of claim 1, wherein the artificial intelligence and machine learning engine is further configured to learn from each re-engagement instance to improve the accuracy of context analysis and response generation over time, based on feedback received through the customer interaction history database and the effectiveness of previous re-engagement attempts.
